(19) United States
(12) Patent Application Publication
(10) Pub. No.: US 2008/0239100 A1
(43) Pub. Date: Oct. 2, 2008

(54) Event Based Picture Storage

(75) Inventor: Nils Christensson, Vellinge (SE)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 12/057,969

(22) Filed: Mar. 28, 2008

Related U.S. Application Data
(60) Provisional application No. 60/920,817, filed on Mar. 30, 2007.

(51) Int. Cl. H04N 5/76

(52) U.S. Cl. 348/231.99; 348/231.6

(57) ABSTRACT

There is provided an apparatus, an integrated circuit, a digital camera, and a method for automatically recording pictures on a digital camera. The digital camera, for example, configured to receive a user-defined prerequisite for recording a picture; capture a plurality of pictures; determine whether at least one picture of the plurality of captured pictures meets the user-defined prerequisite; and store the at least one picture which meets the user-defined prerequisite if at least one picture of the plurality of captured pictures meets the user-defined prerequisite.

### CROSS-REFERENCE TO RELATED APPLICATIONS

This application claims benefit to U.S. Provisional Application No. 60/920,817, filed on Mar. 30, 2007, which incorporated by reference in its entirety herein.

### BACKGROUND OF THE INVENTION

The present invention refers to recording of pictures or sequences of pictures on a digital camera, in particular to facilitating the recording of very short events which are difficult to capture.

A typical problem of a photographer is to capture extremely short events. Most times, a picture is captured a bit too early or a bit too late. Occasions in the context of such short events desired to be captured are numerous. Some examples are sport events, car races, animals on the run, natural phenomena, fireworks, and many more.

With the high processing power and high bit rates that multimedia chips in digital cameras support, selection of new ways of capturing pictures will be possible using digital cameras. One approach powerful multimedia chips may allow for is to record pictures continuously and store them all to a storage memory for post processing and selection. However, this approach requires a fast memory having large storage capacity.

Therefore, there is a need for a method and an apparatus for use in digital cameras which enable a user to capture very short events and utilize storage capacity available for storing of image data of captured pictures more efficiently.

### BRIEF SUMMARY OF THE INVENTION

The invention provides a method for automatically recording pictures, an apparatus, an integrated circuit, and a digital camera, substantially as shown in and/or described in connection with at least one of the figures, as set forth more completely in the claims.

In accordance with an aspect of the invention, there is provided a method for automatically recording pictures on a digital camera. The method includes receiving a user-defined prerequisite for recording a picture; capturing a plurality of pictures; determining whether at least one picture of the plurality of captured pictures meets the user-defined prerequisite; and storing the at least one picture which meets the user-defined prerequisite if at least one picture of the plurality of captured pictures meets the user-defined prerequisite.

In accordance with a further aspect of the invention, there is provided an apparatus that includes an image processor for processing raw data received from a sensor of a digital camera to image data; a memory for buffering the image data; a detector for extracting values, based on a user-defined prerequisite, from the image data buffered in the memory; and a comparator configured to compare the extracted values with the user-defined prerequisite to determine if the user-defined prerequisite is met by at least one picture captured by the digital camera and, if the user-defined prerequisite is met by at least one picture, to cause image data of the at least one picture to be stored in a storage memory.

Further features, aspects and advantages of the present invention will become apparent from the following detailed description of the invention made with reference to the accompanying drawings.

### BRIEF DESCRIPTION OF THE DRAWINGS

The accompanying drawings are included to provide a further understanding of the present invention and are incorporated in and constitute a part of this specification. The drawings illustrate embodiments of the present invention and together with the description serve to explain the principles of the invention. Other embodiments of the present invention and many of the intended advantages of the present invention will be readily appreciated as they become better understood by reference to the following detailed description.

FIG. 1 shows an exemplary and simplified schematic diagram of a digital camera according to an embodiment of the invention;

FIG. 2 shows an exemplary and simplified schematic diagram of a digital camera according to a further embodiment of the invention.

FIG. 3 shows a schematic simplified flowchart illustrating a method for automatically recording pictures on a digital camera in accordance with a further embodiment of the invention.

### DETAILED DESCRIPTION OF THE INVENTION

In the following Detailed Description, reference is made to the accompanying drawings, which form a part hereof, and in which is shown by way of illustration specific embodiments in which the invention may be practiced. It is to be understood that other embodiments may be utilized and structural or other changes may be made without departing from the scope of the present invention. The following detailed description, therefore, is not to be taken in a limiting sense, and the scope of the present invention is defined by the appended claims.

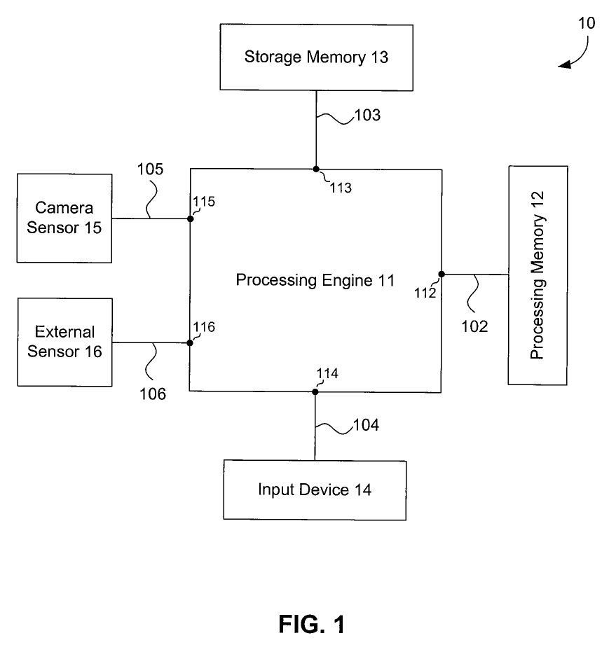

FIG. 1 shows an exemplary and simplified schematic diagram of a digital camera according to an embodiment of the invention.

The digital camera 10 pictured in FIG. 1 comprises a processing engine 11, a processing memory 12, e.g. random access memory (RAM), a storage memory 13, e.g. flash memory, portable memory, disk drive, etc., an input device 14, a camera sensor 15, e.g. CCD (charge coupled device) sensor, or CMOS (complementary symmetry metal oxide semiconductor) sensor, and an external sensor 16.

The processing engine is connected with its in-/output 112 to the processing memory 12 via connection 102 and with its output 113 to the storage memory 13 via connection 103. Input device 14 is connected to input 114 of the processing engine 11 via connection 104. Camera sensor 15 is connected to input 115 of the processing engine 11 via connection 105 and external sensor 16 is connected to input 116 of the processing engine 11 via connection 106.

A user who intends to capture and record a short event automatically using the digital camera 10 may begin with selecting a prerequisite for recording a picture from a plurality of prerequisites by means of the input device 14 of the digital camera 10. The input device 14 may be an input device commonly used in digital cameras for adjusting settings for capturing pictures or viewing already recorded pictures, etc., which is further adapted to provide options of prerequisites for recording pictures. Examples for prerequisites are:
certain brightness thresholds the value of which is specified by the user via the input device 14;
certain speed thresholds for moving objects the value of which is specified by the user via the input device 14;
that the eyes of a person in a picture are open; and
that a person in a picture is a certain previously identified person; etc.

When additionally using external sensor 16 for detecting desired events, further prerequisites are selectable depending on the utilized external sensor 16.

For example, an external microphone may send a respective signal when a strong sound is detected which exceeds a user-defined sound intensity threshold. However, it is also possible to use a microphone already integrated in the digital camera.

In general, all other means for detecting and/or measuring a quantity to be observed than the image processing of the image data of the captured picture itself are herein referred to as “external sensors”.

Further examples for external sensors are given below. However, the list is for exemplifying reasons only and embodiments of the invention are not limited to these examples:
a thermometer;
a light sensor;
a motion detector;
a sensor for electromagnetic radiation;
a gas sensor;
a proximity sensor;
an accelerometer;
a gyro sensor;
a clock for specifying a certain time;
a GPS device for specifying a certain location; etc.

After specifying the prerequisite for recording and storing a picture, the user may specify further parameters for recording pictures by means of the input device 14 of the digital camera 10, such as e.g. the number of pictures to be stored and the rate at which the pictures are to be stored.

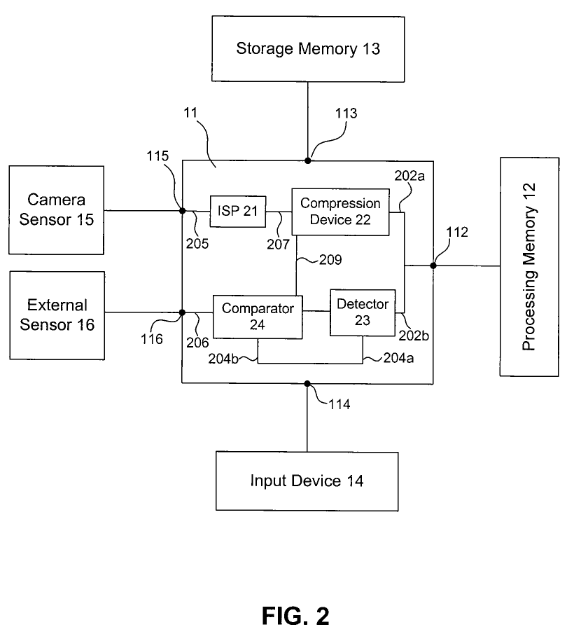

Then the user may activate the capture process of the digital camera 10 to cause the camera sensor 15 to capture a plurality of pictures. Processing engine 11 which is shown in detail in FIG. 2 may continuously receive, via input 115, a stream of raw image data of the pictures captured by the camera sensor 15.

The processing engine 11 pictured in FIG. 2 comprises an image signal processor (ISP) 21, a compression device 22, a detector 23, and a comparator 24.

The image signal processor 21 is connected to input 115 via connection 205 and to the compression device 22 via connection 207. The compression device 22 is connected to the image signal processor 21, to the comparator 24 via connection 209, to in-/output 112 via connection 202a, and to output 113 via connection 203. The detector 23 is connected to the comparator 24 via connection 208, to in-/output 112 via connection 202b, and to input 114 via connection 204a. The comparator is connected to the detector 23, to the compression device 22, to input 114 via connection 204b and to input 116 via connection 206.

The signal processor 21 receives the stream of raw image data of the pictures captured by the camera sensor 15 from input 115 and processes the raw image data to generate the actual digital image data of the pictures captured by the camera sensor 15. The digital image data is then forwarded from the signal processor to the compression device via connection 207. The compression device 22 may advantageously compress the received digital image data, but the data compression is not mandatory. For the optional image data compression, conventional compression techniques such as e.g. JPEG, TIFF, MPEG, etc. may be used.

The compressed (or uncompressed) image data is buffered in the processing memory 12. The detector 23 retrieves the image data buffered in the processing memory 12 to extract information or calculate values of quantities to be determined, wherein the information to be extracted and the quantities to be determined are specified by the user-defined prerequisite. The extracted information and calculated value, respectively, is sent to the comparator 24.

The comparator 24 compares the value and information, respectively, with the user-defined threshold for this quantity and the information, respectively, comprised in the user-defined prerequisite received from the input device 14 via input 114 of the processing engine 11. If the comparison shows that the user-defined prerequisite is met the comparator causes storing of image data presently buffered in the processing memory 12 to the storage memory 13. If the comparison shows that the user-defined prerequisite is not met the comparator causes the image data presently buffered in the processing memory 12 to be discarded.

As the user-defined prerequisite may be a threshold i.e. an actual quantity represented by a real number, or a quasi “logical prerequisite”, such as “Are the eyes of a person closed or not?”, it was differentiated between “quantity” and “information” above.

Further parameters for the storing of the image data may also be specified by the user. Accordingly, the user may specify:

How many pictures (or more exactly: the image data thereof) are to be stored;

The first picture (of a series of pictures) to be stored i.e. whether the picture meeting the prerequisite is the first picture to be stored or whether a certain number of prior pictures (pictures captured before the picture meeting the prerequisite) are to be stored, too, etc.;

The rate at which the pictures are to be stored, i.e. whether each picture of a captured series, or every second, third, fourth, etc. picture of a series is to be stored.

The times when it is determined if a picture meets the user-defined prerequisite are also variable. For example, it may continuously be determined if a just captured picture meets the user-defined prerequisite, i.e. after capturing a picture it is each time determined if it meets the prerequisite. Alternatively, a series of a certain number of pictures may be captured and buffered in the processing memory 12 before determining if any picture of the buffered series of pictures meets the prerequisite. Naturally, the number of pictures buffered in the processing memory 12 is limited by the storage capacity of the processing memory 12.

Pictures can be captured continuously by the camera sensor 15 irrespective of the captured pictures being stored or not. Therefore, it is also possible to record several short events automatically if, preferably for each picture captured by the camera sensor 15, it is determined whether the respective picture meets the user-defined prerequisite and is therefore desired to be stored in the storage memory 13.

In the following some examples for the comparison carried out by the comparator 24 will be given.

### Brightness Threshold

The logic comparator 23 receives the brightness of a respective picture as a first input and a brightness threshold specified by the user as a second input. The brightness of a respective picture may determined from the image data by conventional image processing techniques or may be measured by the external device 16. Then, the logic comparator 23 compares the data of the two inputs to determine whether the brightness of the respective picture is greater than the user-defined threshold.

### Speed Threshold

To determine the speed of a moving object in a series of pictures, motion vectors of the series of pictures may be examined. In general, it is computationally very complex to calculate motion vectors from image data of a series of pictures. However, MPEG decoding of video image data which is commonly used in digital cameras provides a convenient way of obtaining motion vectors. Motion vectors are used for MPEG decoding and, in particular, MPEG compressed image data comprises motion vectors available for further processing. Therefore, it is very simple to extract motion vectors from MPEG data.

If it is desired to determine whether there is a significant motion present in a picture, motion pictures in a certain area in the picture are compared. If the difference of two motion vectors in the area exceeds a user-defined threshold (comprised in the user-defined prerequisite) significant motion or rather an object moving with a certain speed (or faster) is detected.

However, also other means, e.g. a motion detector, could be used for determining whether there is significant motion present in an observed area.

### Face Recognition

Face recognition techniques may be used to determine whether the eyes of a person in a picture are open or whether a person in a picture is a certain previously identified person. In this case the detector extracts and transmits information indicating if the prerequisite is met or not, a comparison with a threshold is not required. Therefore, the comparator only determines, based on the extracted information if the prerequisite is met or not.

The foregoing discussion of examples for prerequisites and of possible implementations for determining whether the respective prerequisite is met serves only as an exemplifying illustration for a better understanding of the invention and is not to be understood in any limiting sense.

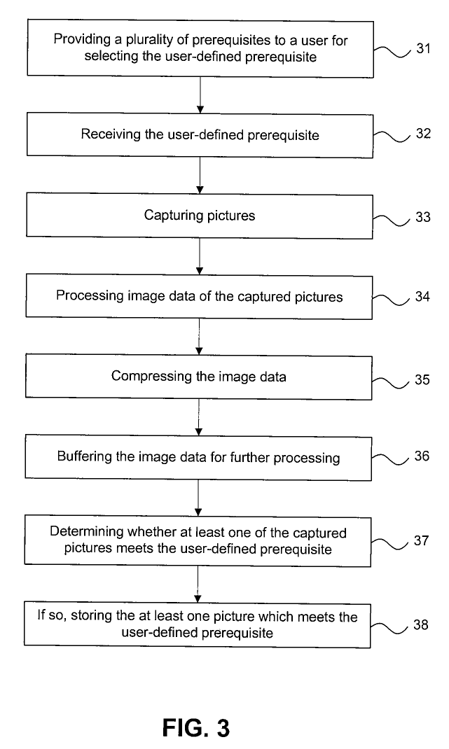

FIG. 3 shows a schematic simplified flowchart illustrating a method for automatically recording pictures on a digital camera in accordance with a further embodiment of the invention.

In the first step, 31, shown in the flowchart of FIG. 3, a plurality of prerequisites is provided to a user for selecting the user-defined prerequisite.

In the next step, 32, the user-defined prerequisite for recording a picture selected by the user is received.

In step 33, pictures are captured by means of a sensor of a digital camera, and image data of the captured pictures are processed by an image signal processor in step 34.

The image data processed by the image signal processor may be compressed and then buffered for further processing in steps 35 and 36, respectively.

In step 37, it is determined whether at least one of the captured pictures meets the user-defined prerequisite.

If at least one captured picture meets the user-defined prerequisite, image data of the at least one captured picture which meets the user-defined prerequisite is stored in step 38.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method for automatically recording pictures on a digital camera, the method comprising:
receiving a user-defined prerequisite for recording a picture;
capturing a plurality of pictures;
determining whether at least one picture of the plurality of captured pictures meets the user-defined prerequisite;
if at least one picture of the plurality of captured pictures meets the user-defined prerequisite, storing the at least one picture which meets the user-defined prerequisite.

2. The method of claim 1, wherein the capturing of the plurality of pictures is carried out independently from storing the at least one picture which meets the user-defined prerequisite.

3. The method of claim 1, further comprising providing a plurality of prerequisites to a user for selecting the user-defined prerequisite.

4. The method of claim 1, further comprising receiving, from an external sensor, information for the determining whether at least one picture of the plurality of captured pictures meets the user-defined prerequisite.

5. The method of claim 4, wherein the external sensor is selected from a group consisting of:
a microphone, a light sensor, a thermometer, a GPS device, a gas sensor, a proximity sensor, an accelerometer, a gyro sensor, and a sensor for electromagnetic radiation.

6. The method of claim 1, wherein image processing techniques are used for the determining whether at least one picture of the plurality of captured pictures meets the user-defined prerequisite.

7. The method of claim 6, wherein the image processing techniques are used to detect a brightness level of a captured picture and the detected brightness level is compared with a user-defined brightness threshold to determine whether at least one picture of the plurality of captured pictures meets the user-defined prerequisite.

8. The method of claim 6, wherein the image processing techniques are used to calculate motion vectors of the captured pictures.

9. The method of claim 6, wherein the image processing techniques comprise face recognition techniques.

10. The method of claim 9, wherein the face recognition techniques are used to determine whether the eyes of a person in the captured picture are closed.

11. The method of claim 9, wherein the face recognition techniques are used to determine whether a person in the captured picture is a certain, previously identified person.

12. The method of claim 1, further comprising compressing the image data of the plurality of captured pictures.

13. An apparatus comprising:
an image processor for processing raw data received from a sensor of a digital camera to image data;
a memory for buffering the image data;
a detector for extracting values, based on a user-defined prerequisite, from the image data buffered in the memory;
a comparator configured to compare the extracted values with the user-defined prerequisite to determine if the user-defined prerequisite is met by at least one picture captured by the digital camera and, if the user-defined prerequisite is met by at least one picture, to cause image data of the at least one picture to be stored in a storage memory.

14. The apparatus of claim 13, further comprising a compression device for compressing the image data processed by the image processor.

15. The apparatus of claim 14, wherein the compression device is configured to generate MPEG encoded image data.

16. The apparatus of claim 15, wherein the detector is configured to extract motion vectors from the MPEG encoded image data.

17. The apparatus of claim 13, further comprising an external sensor providing information for determining if the user-defined prerequisite is met by at least one picture captured by the digital camera, wherein the external sensor is selected from a group consisting of:
a microphone, a light sensor, a motion detector, a thermometer, a GPS device, a gas sensor, a proximity sensor, an accelerometer, a gyro sensor, and a sensor for electromagnetic radiation.

18. The apparatus of claim 13, wherein the detector is configured to extract a brightness level of a picture from the image data of the captured pictures and wherein the comparator compares the extracted brightness level with a brightness threshold specified in the user-defined prerequisite.

19. The apparatus of claim 13, wherein the memory for buffering the image data is a random access memory.

20. A digital camera comprising:
a camera sensor for generating raw data of captured pictures;
an image processor for processing the raw data of the captured pictures to image data;
a memory for buffering the image data;
a detector for extracting values, based on a user-defined prerequisite, from the image data buffered in the memory;
a comparator configured to compare the extracted values with the user-defined prerequisite to determine if the user-defined prerequisite is met by at least one captured picture and, if the user-defined prerequisite is met by at least one picture, to cause image data of the at least one picture to be stored in a storage memory.

21. The digital camera of claim 20, further comprising a compression device for compressing the image data processed by the image processor.

22. The digital camera of claim 20, further comprising an input device for selection of the user-defined prerequisite from a plurality of predetermined prerequisites.

23. The digital camera of claim 20, wherein the memory for buffering the image data is a random access memory.

24. The digital camera of claim 20, wherein the storage memory is selected from a group containing flash memory, portable memory, portable flash memory, and disk drives.

25. The digital camera of claim 20, further comprising an external sensor providing information to the comparator for determining if the user-defined prerequisite is met by at least one captured picture, wherein the external sensor is selected from a group consisting of: a microphone, a light sensor, a motion detector, a thermometer, a GPS device, a gas sensor, a proximity sensor, an accelerometer, a gyro sensor, and a sensor for electromagnetic radiation.

26. An integrated circuit, comprising:
means for extracting values, based on a user-defined prerequisite, from received image data of a plurality of pictures captured by a digital camera, and
means for comparing the extracted values with a user-defined prerequisite to determine if the user-defined prerequisite is met by at least one picture of the plurality of pictures and, if the user-defined prerequisite is met by at least one picture, to cause image data of the at least one picture to be stored in a storage memory.
